(19) United States
(12) Patent Application Publication
(10) Pub. No.: US 2008/0162799 A1
(43) Pub. Date: Jul. 3, 2008

(54) Mechanism for write optimization to a memory device

(76) Inventors: Bryan Spry, Portland, OR (US); Nagi Aboulenein, Portland, OR (US); Steve Kulick, Portland, OR (US)

Correspondence Address: INTEL/BLAKELY, 1279 OAKMEAD PARKWAY, SUNNYVALE, CA, 94085-4040, US

(21) Appl. No.: 11/648,483

(22) Filed: Dec. 28, 2006

(51) Int. Cl. G06F 13/14

(52) U.S. Cl. 711/104

(57) ABSTRACT

According to one embodiment, a memory controller is disclosed. The memory controller includes a scheduler to schedule memory transactions to the DIMM and a write address queue to accumulate the write requests while the memory controller is operating in a first mode and to release the write requests to the scheduler whenever the memory controller is operating in a second mode.

### FIELD OF THE INVENTION

The present invention relates to computer systems; more particularly, the present invention relates to memory devices.

### BACKGROUND

A dual in-line memory module (DIMM) is a series of random access memory (RAM) integrated circuits mounted on a printed circuit board and designed for use in personal computer systems. Fully Buffered DIMMs (FBDs) include an advanced memory buffer (AMB), which allows for greater memory capacity on a memory channel. The AMB operates an intermediary between the memory device and a memory controller. The interface to the AMB is a high speed narrow pin count bus. However, this bus has the limitation of allowing writes at half the maximum command bandwidth to the memory device. Thus, care is taken in memory controller design to not starve the performance critical reads from using available command slots on the bus.

### BRIEF DESCRIPTION OF THE DRAWINGS

The invention is illustrated by way of example and not limitation in the figures of the accompanying drawings, in which like references indicate similar elements, and in which:

FIG. 1 is a block diagram of one embodiment of a computer system;

FIG. 2 illustrates one embodiment of a memory controller coupled to DIMMs;

FIG. 3 illustrates one embodiment of a memory controller;

FIG. 4 are timing diagrams illustrating one embodiment of the operation of performing memory transactions;

FIG. 5 are timing diagrams illustrating another embodiment of the operation of performing memory transactions;

FIG. 6 are timing diagrams illustrating still another embodiment of the operation of performing memory transactions; and

FIG. 7 is a block diagram of another embodiment of a computer system.

### DETAILED DESCRIPTION

A mechanism for write optimization to a memory device is described. In the following detailed description of the present invention numerous specific details are set forth in order to provide a thorough understanding of the present invention. However, it will be apparent to one skilled in the art that the present invention may be practiced without these specific details. In other instances, well-known structures and devices are shown in block diagram form, rather than in detail, in order to avoid obscuring the present invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

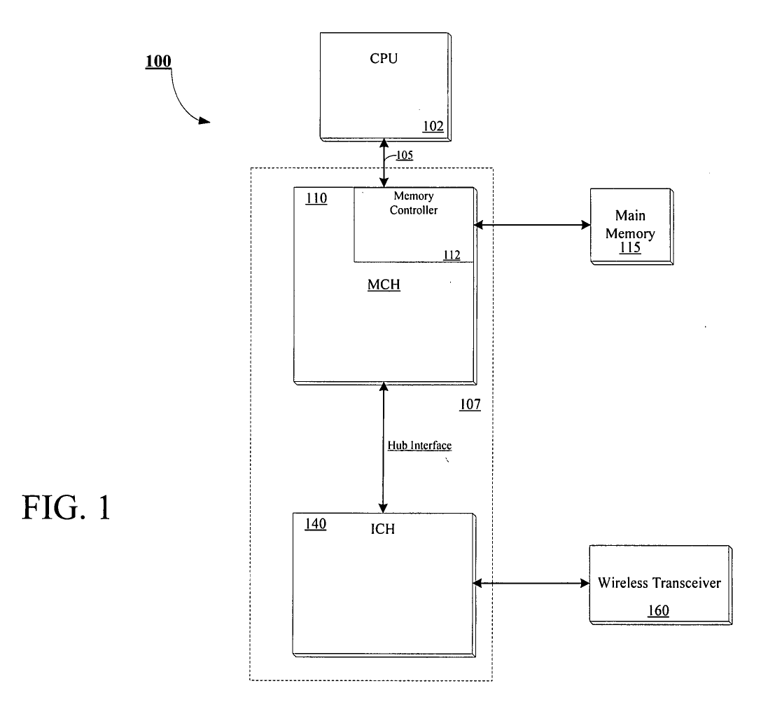

FIG. 1 is a block diagram of one embodiment of a computer system 100. Computer system 100 includes a central processing unit (CPU) 102 coupled to interconnect 105. In one embodiment, CPU 102 is a processor in the Pentium® family of processors Pentium® IV processors available from Intel Corporation of Santa Clara, Calif. Alternatively, other CPUs may be used. For instance, CPU 102 may be implemented multiple processors, or multiple processor cores.

In a further embodiment, a chipset 107 is also coupled to interconnect 105. Chipset 107 may include a memory control hub (MCH) 110. MCH 110 may include a memory controller 112 that is coupled to a main system memory 115. Main system memory 115 stores data and sequences of instructions that are executed by CPU 102 or any other device included in system 100.

In one embodiment, main system memory 115 is a fully-buffered DIMM (FBD) incorporating dynamic random access memory (DRAM) devices; however, main system memory 115 may be implemented using other memory types. Additional devices may also be coupled to interconnect 105, such as multiple CPUs and/or multiple system memories.

MCH 110 may be coupled to an input/output control hub (ICH) 140 via a hub interface. ICH 140 provides an interface to input/output (I/O) devices within computer system 100. ICH 140 may support standard I/O operations on I/O interconnects such as peripheral component interconnect (PCI), accelerated graphics port (AGP), universal serial interconnect (USB), low pin count (LPC) interconnect, or any other kind of I/O interconnect (not shown). In one embodiment, ICH 140 is coupled to a wireless transceiver 160.

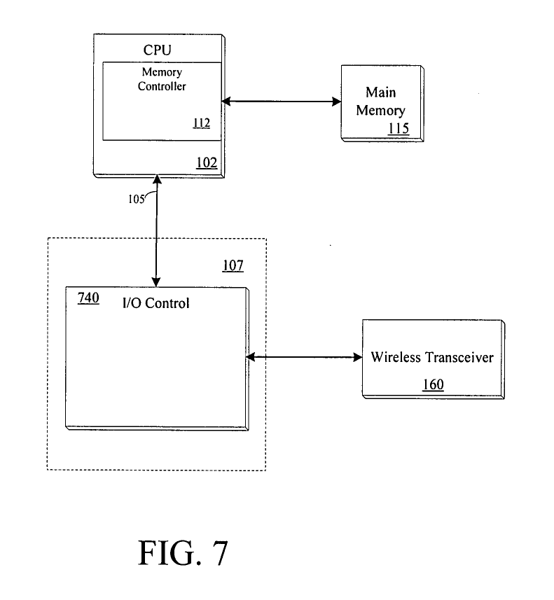

FIG. 7 illustrates another embodiment of computer system 100. In this embodiment, memory controller 112 is included within CPU 102. As a result, memory 115 is coupled to CPU 102. Further chipset 107 includes an I/O control hub 740.

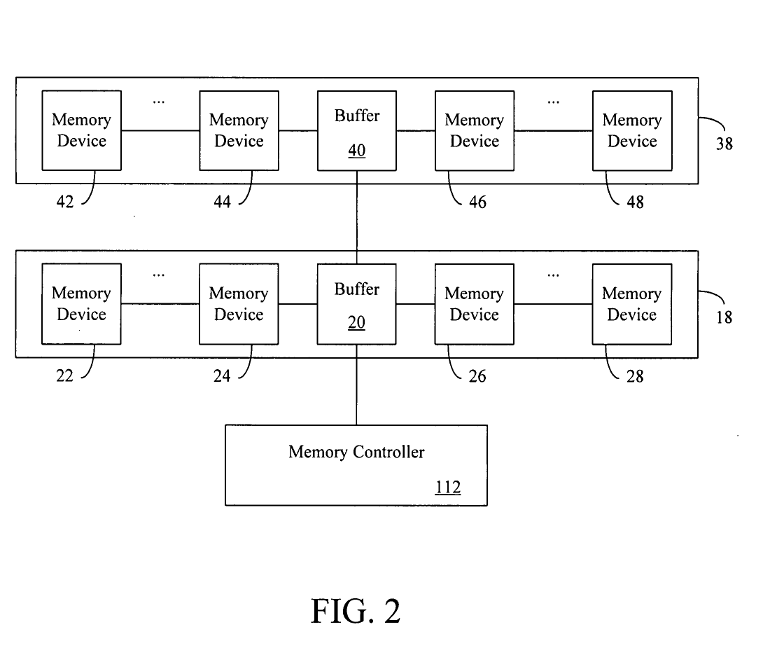

FIG. 2 illustrates one embodiment of memory controller 112 coupled to DIMMs (or FBDs) 18 and 38. According to one embodiment, each DIMM includes an advanced memory buffer (AMB) (20 and 40), and memory modules coupled to either side of the AMBs. DIMMs 18 and 38 include a serial interface between memory controller 112 and the buffers that enables an increase to the width of the memory without increasing the pin count of the memory controller.

Thus, memory controller 112 does not write to the memory modules directly, but via the AMBs. The AMBs compensate for signal deterioration by buffering and resending the signal. Further, the AMBs may also provide error correction, without posing any overhead on memory controller 112. Read and write data buses are not shared as they are in FBDs. Further, the write bus bandwidth is half that of the read bus while the command bus is shared

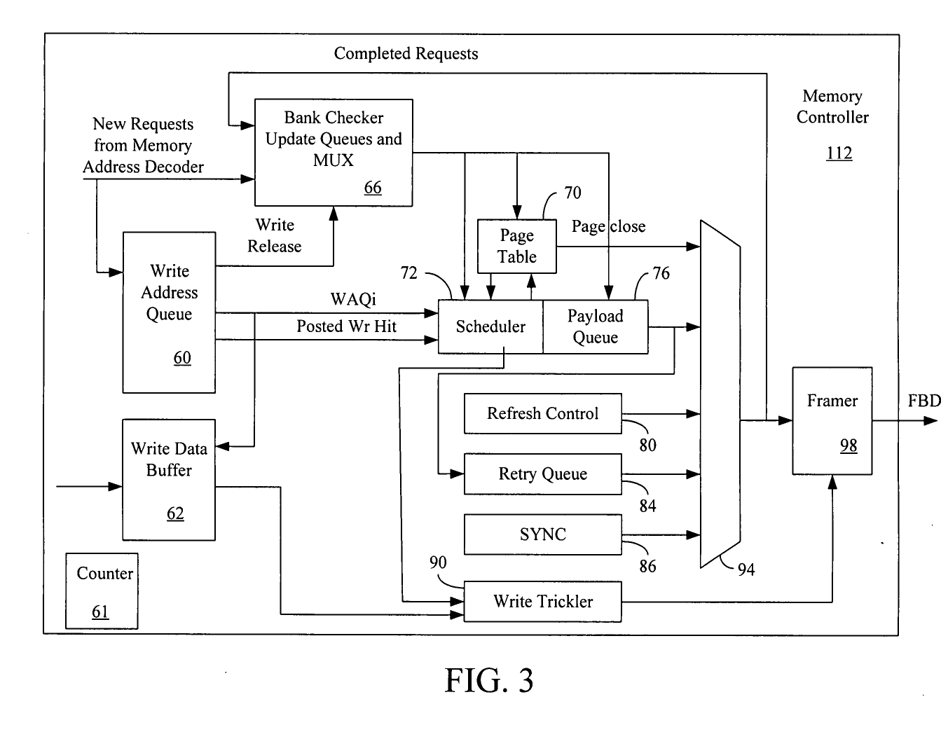

FIG. 3 illustrates one embodiment of memory controller 112. Memory controller 112 includes a write address queue 60, write data buffer 62, schedule and write trickier 90, among various other illustrated components. In one embodiment, scheduler 72 is responsible for transmitting appropriate DRAM commands to the AMBs on a particular memory channel while tracking timing parameters and trickling write data.

In a further embodiment, DRAM page hits are optimized via page table 70 to minimize the number of page openings and closings. Scheduler 72 includes read and write bank checkers to track the timing and sequence of commands for each read and write. According to one embodiment, write requests are queued in a separate write address queue 60, for issue to a write bank checker 66. Both page table 70 and scheduler 72 track a page state on a per bank basis. Thus, page table 70 enables memory controller 112 to keep pages open and properly track the pages when a request has completed access to the pages. Write bank checker 66 checks timing constraints of a particular bank a write request is to access.

According to one embodiment, write address queue 60 stores addresses and commands for up to thirty-two cache lines of write requests per address channel. Meanwhile, the data corresponding to the addresses is stored in write buffer 62. Whenever data is to be written to a DIMM, write address queue 60 transmits a write release signal to scheduler 72 indicating write requests are to be processed by scheduler 72.

In one embodiment, whenever a read request is received that would read from a bank that is to be written to by a write request stored in write address queue 60, the read request is scheduled out to a DIMM via scheduler 72. However when the data is to be received back at memory controller 112, the data is retrieved from write data buffer 62, rather than a DIMM.

According to one embodiment, memory controller 122 may operate in a Read Major Mode or a Write Major Mode. Under normal conditions, memory controller 112 operates in the Read Major Mode where reads are favored over writes as they are performance critical. Thus, writes are only released to write address queue 60 whenever there are no reads to the same bank.

However, if too many writes are allowed to accumulate, system performance may be affected, resulting in system stalls due to a lack of write posting buffers or other resources. Thus in the Write Major Mode, scheduler 72 favors writes to free up memory controller 112 resources. According to one embodiment, memory controller 112 switches from Read Major Mode to Write Major Mode whenever write address queue 60 reaches a predetermined threshold of filled cache lines.

In one embodiment, there is a switch from Read Major Mode to Write Major Mode once twenty-eight of the lines have been filled. However, in other embodiment, the threshold is programmable to be set at a threshold desired by a system designer. In a further embodiment, the number of released writes is limited in the Write Major Mode because the data may be trickled from write trickier 90 to the AMBs at half the bandwidth of commands. Moreover, there may be a switch from the Write Major Mode back to the Read Major Mode once a predetermined number of write requests have been released from queue 60.

In one embodiment, write address queue 60 controls the write release number and timings using write grouping. As discussed above, writes requests are released to scheduler 72 once the Write Major Mode threshold of outstanding writes is reached. Once this occurs, writes may be released in various ways.

One mechanism to release writes is to release all of the writes in write address queue 60 until the number of writes in write address queue 60 is below a certain threshold. However, this solution is not efficient because it results in read requests being starved.

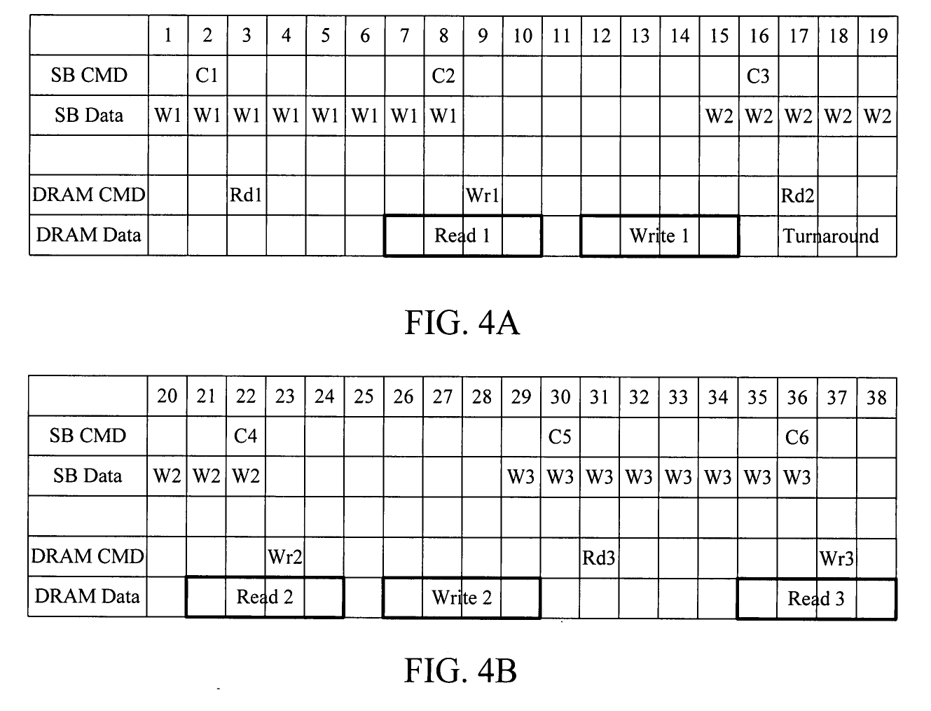

Another mechanism may involve alternating write requests and read requests once the Write Major Mode is entered. FIGS. 4A and 4B represent a timing diagram illustrating such a mechanism. As shown in FIGS. 4A and 4B, this mechanism results in a poor management of the AMB write buffer and wastes FBD write channel bandwidth, resulting in writes being limited to every 14 clock cycles because of penalties incurred for turning the bus around.

Referring back to FIG. 3, a mechanism may be implemented to pool a number of writes to be released in bursts to scheduler 72. In such an embodiment, a programmable counter 61 is enabled to count the number of writes requests going to scheduler 72. Counter 61 may have a range of 1 to 8 and can be optimized for system load and configuration. However in one embodiment, 4 write bursts are implemented.

Once write release counter 61 reaches its threshold (e.g. 4), all writes are blocked from being released. Counter 61 is reloaded once the trickles are complete for all of the released writes. In a further embodiment, writes may be released after a programmable delay. This delay is to allow additional slots for read commands to be issued. In one embodiment, a delay of zero is implemented.

The effect of write grouping on the FBD link is that N command slots are used for writes while N*2 data slots are used to trickle the write data. Read commands are allowed once there are no write CAS commands to be sent from the scheduler. The write grouping opens up these slots by optimizing the command bandwidth.

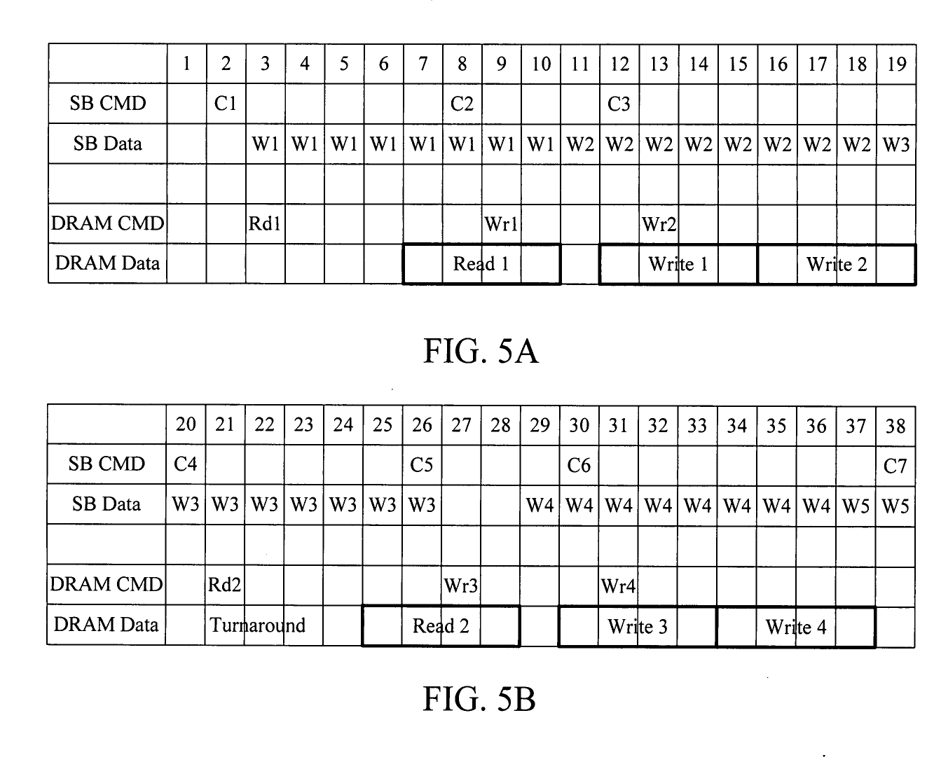

FIGS. 5A and 5B represent a timing diagram illustrating one embodiment of the burst mechanism interleaving one read between two burst writes. As shown in FIGS. 5A and 5B, there is a good management of the AMB write buffer with a sufficiently large burst length to reduce turnaround.

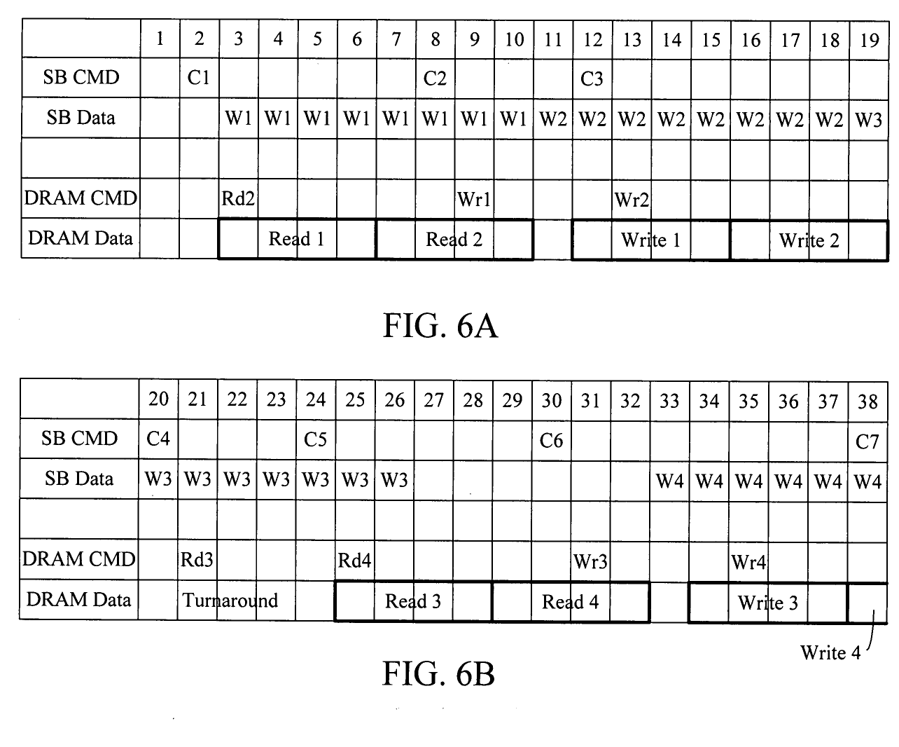

FIGS. 6A and 6B represent a timing diagram illustrating one embodiment of the burst mechanism interleaving two reads between two burst writes, resulting in a 1:1 split. As shown in FIGS. 6A and 6B, there is a tradeoff between read bandwidth and write bandwidth.

The above-described mechanism optimizes write requests to DRAM by grouping writes to prevent starving of read requests when operating in a write mode.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims, which in themselves recite only those features regarded as essential to the invention.

What is claimed is:

1. A memory controller comprising:
a scheduler to schedule memory transactions to a dual in-line memory module (DIMM); and
a write address queue to store write requests to the DIMM, to accumulate the write requests while the memory controller is operating in a first mode and to release the write requests to the scheduler whenever the memory controller is operating in a second mode.

2. The memory controller of claim 1 wherein the write requests write are released from the address queue to the scheduler as a pool of write requests.

3. The memory controller of claim 2 further comprising a programmable counter to count a predetermined number of requests released to the scheduler as the pool of write requests.

4. The memory controller of claim 3 wherein write requests are blocked from being released once the counter counts to the predetermined number.

5. The memory controller of claim 4 further comprising a write buffer to store data corresponding to the write requests stored in the write address queue.

6. The memory controller of claim 5 further comprising a write trickier, coupled to the write buffer, to trickle the write data corresponding to the released write requests to the DIMM.

7. The memory controller of claim 6 wherein the counter is reset once the write data is trickled from the trickier.

8. The memory controller of claim 7 wherein read requests are scheduled by the scheduler while the write data is trickled from the trickier.

9. The memory controller of claim 1 wherein the memory controller switches from the first mode to the second mode once the write address queue accumulates a predetermined number of write requests.

10. The memory controller of claim 9 wherein the memory controller switches from the second mode back to the first mode once the write address queue has released a predetermined number of write requests.

11. A method comprising:
scheduling read request to a dual in-line memory module (DIMM) while a memory controller is operating in a first mode;
accumulating write requests in a write address queue while the memory controller is operating in the first mode;
switching from the first mode to the second mode; and
releasing the write requests to the scheduler from the write address queue while the memory controller is operating in the second mode

12. The method of claim 11 wherein releasing the write requests to the scheduler further comprises releasing a pool of write requests to the scheduler.

13. The method of claim 12 further comprising counting a predetermined number of requests released to the scheduler as the pool of write requests.

14. The memory controller of claim 13 further comprising blocking write requests from being released upon counting to the predetermined number.

15. The memory controller of claim 11 further comprising trickling write data corresponding to the released write requests to the DIMM.

16. The method of claim 11 wherein the memory controller switches from the first mode to the second mode once the write address queue accumulates a predetermined number of write requests.

17. A system comprising:
a dual in-line memory module (DIMM); and
a memory controller comprising;
a scheduler to schedule memory transactions to the DIMM; and
a write address queue to accumulate the write requests while the memory controller is operating in a first mode and to release the write requests to the scheduler whenever the memory controller is operating in a second mode.

18. The system of claim 1 wherein the write requests write are released from the address queue to the scheduler as a pool of write requests.

19. The system of claim 2 wherein the memory controller further comprises a programmable counter to count a predetermined number of requests released to the scheduler as the pool of write requests.

20. The system of claim 19 wherein the memory controller further comprises a write buffer to store data corresponding to the write requests stored in the write address queue.
